(19) United States
(12) Patent Application Publication
(10) Pub. No.: US 2007/0055556 A1
(43) Pub. Date: Mar. 8, 2007

(54) Spreadsheet Generator

(76) Inventors: Elizabeth Grace Frank-Backman, Jerusalem (IL); Ziv Z. Hellman, Jerusalem (IL)

Correspondence Address: COLLEN IP, THE HOLYOKE MANHATTAN BUILDING, 80 SOUTH HIGHLAND AVENUE, OSSINING, NY, 10562, US

(21) Appl. No.: 11/428,951

(22) Filed: Jul. 6, 2006

Related U.S. Application Data
(60) Provisional application No. 60/696,870, filed on Jul. 6, 2005.
(60) Provisional application No. 60/709,742, filed on Aug. 19, 2005.

(51) Int. Cl. G06F 9/44; G06F 17/00

(52) U.S. Cl. 705/7; 715/503

(57) ABSTRACT

A system and method automates the creation of business models via generators that generate data structures and models based on general assumptions regarding business models. A time series generator automatically generates a time series model suitable for creating a spreadsheet, even though the input description of the business model may be time-independent. A cross-category generator creates a cross-category hierarchy, even though the business model is described using independent categorizations, such as market categories, product-line categories, organizational categories, and so on. In this manner, the creator of the business model is freed of the tedium generally associated with creating a business model, and the likelihood of errors in the resultant models is substantially reduced. Further, the same input description of the business model can be used as the source of alternative models, depending upon the requirements of the intended application of the model.

This application claims the benefit of U.S. Provisional Patent Application 60/696,870, filed 6 Jul. 2005, and 60/709,742, filed 19 Aug. 2005.

### BACKGROUND AND SUMMARY OF THE INVENTION

This invention relates to the field of computer systems, and in particular to a method and system for creating business models suitable for processing on computer systems.

Computer systems are often used to model the operation of a business, for financial reporting, planning, and forecasting. The invention of an automated spreadsheet program in the late 1970s, for example, provided a major advancement in the practical use of computers for such business applications. It was one of the first computer applications designed for non-programmers, and specifically for business professionals with little or no programming background. Users could create spreadsheets that presented the financial performance of a business based on actual revenues and expenses, or spreadsheets that projected the future performance of the business based on given assumptions, and so on.

The invention is presented herein using the paradigm of a spreadsheet program as an application that uses a model of a business, or a model of segments of a business, to facilitate an analysis of the operation of the business. Other applications that include the use of a business model will be evident to those skilled in the art, and include, for example, simulation systems, database management systems, inventory control systems, and so on. In like manner, although the invention is presented in the context of business modeling, one of ordinary skill in the art will recognize that the techniques presented herein can be applied other modeling tasks as well.

The strength of a spreadsheet program lies in its ability to use equations that reference cells of the spreadsheet to automatically compute values in other cells of the spreadsheet. For example, a cell at the bottom of a column of ten numbers could be configured to automatically contain the sum of these numbers by a simple formula: =SUM(A1 . . . A10). The cell references A1, A10 identify the first column “A”, and the first “1” through tenth “10” rows, and the ellipsis “ . . . ”identifies the inclusion of all the rows between the first and tenth rows. In most embodiments, the user could merely click on a target cell, and its coordinates would be automatically entered in the equation being created. In complex systems, cells from other spreadsheets can be referenced, so that, for example, spreadsheets that describe the performance of a corporation could be created using data from individual business units within the corporation.

As the complexity of a spreadsheet increases, however, the likelihood of error increases, particularly given that the content of many of the cells is based on reference to contents of other cells, and a mistaken reference can have devastating results. If the mistaken reference is grossly misplaced, the erroneous resultant cell value may be easily recognized, and the mistake corrected; if, on the other hand, the mistaken reference is only slightly off-target, the error may be subtle, and not easily recognized. Debugging such an error, for example, when a ‘Balance Sheet’ doesn't balance, but the source of the error is unknown, can be a time consuming and often frustrating process. An audit of a moderately complex spreadsheet, including a thousand equations or so, often takes days, and sometimes weeks or more, depending upon the complexity and underlying structure of the spreadsheet.

The European Spreadsheet Risks Interest Group (EuSpRIG; www.eusprig.org) maintains a web site that includes compilation of a variety of Spreadsheet-mistake news stories, some of which report spreadsheet mistakes that amounted to millions of dollars, and in some cases, billions of dollars. In the United States, the Sarbanes-Oxley Act was signed into law on 30th Jul. 2002, and introduced highly significant legislative changes to financial practice and corporate governance regulation. It introduced stringent new rules with the stated objective: “to protect investors by improving the accuracy and reliability of corporate disclosures made pursuant to the securities laws”, mandates audits to assure that all financial reports are accurate, and holds corporate executives liable to substantial penalties if they cannot attest to assuring the integrity of corporate financial statements.

One of the fundamental drawbacks of a spreadsheet is the inherent lack of documentation and/or the disjoint nature of the documentation and the actual content of the spreadsheet. The available documentation, if any, is likely to exhibit an underlying structure, whereas the occurrence of equations at cells of a tabular spreadsheet display often obscures this structure, or exhibits a contrary structure.

Similarly, the traditional tabular spreadsheet interface is not conducive to the adoption of a uniform development methodology, and an organization's spreadsheets are likely to be custom-tooled by each individual. These ad hoc development techniques make it difficult for subsequent individuals to support and/or enhance existing spreadsheets, and hinder the application of conventional quality control techniques. This lack of a uniform development methodology also substantially hinders the re-use of existing spreadsheets or parts of spreadsheets in other applications, thereby substantially increasing the cost of development of new spreadsheets.

A number of different approaches have been adopted in an attempt to better manage the development of spreadsheets, to reduce the likelihood of errors in spreadsheets, and/or to simplify the audit of spreadsheets. These approaches generally fall into one of two categories: systems and methods that improve the user interface for developing spreadsheets, and systems and methods that facilitate the audit or analysis of existing spreadsheets. Ideally, a system that is used to improve the user interface for developing spreadsheets will also facilitate an analysis of the resultant spreadsheets.

In “Modeling Spreadsheet Audit: A Rigorous Approach to Automatic Visualization”, Report A-1998-5, University of Joensuu, Jorma Sajaneimi presents a technique for analyzing a spreadsheet that includes drawing arrows representing the use of one cell, or a group of cells, at another cell. Using such a system, misplaced references are often typically identified. In “Goals and Plans in Spreadsheet Calculation”, Report A-1999-1, University of Joensuu, Jorma Sajaneimi et al. present a technique for recognizing a structure underlying a spreadsheet by creating directed graphs that link equations in the spreadsheet. Similarly, US Published Patent Application 2003/0106040, “PARSER, CODE GENERATOR, AND DATA CALCULATION AND TRANSFORMATION ENGINE FOR SPREADSHEET CALCULATIONS” filed 15 Aug. 2002 for Michael H. Rubin et al., and incorporated by reference herein, teaches a process that recognizes predefined data objects and structures in a spreadsheet, and generates spreadsheet-independent program source code to effect the operations defined in the spreadsheet. In “EXCELSIOR: BRINGING THE BENEFITS OF MODULARIZATION TO EXCEL”, published in the European Spreadsheet Risks Interest Group (EuSpRIG) 2005 Conference Report, Jocelyn Paine discloses a formal mathematical representation for spreadsheets, and presents techniques for transforming a conventional spreadsheet into this mathematical representation. A programming language is also presented that uses this mathematical representation, and is suitable for creating spreadsheets. However, as the term “programming language” implies, the use of this language is well suited for programmers, but poorly suited for accountants or business managers who are not typically programmers.

A number of commercial systems are also available to facilitate the creation of spreadsheets, including “ExcelWriter” by SoftArtisans; “Model Master” by J. Paine; “Paradigm” by Management Consultants Limited; “Quantrix Modeler” by Quantrix; and others. In “Excel Writer”, the user creates a template on a spreadsheet that includes data markers, and then generates a new spreadsheet by running a script that opens the template and couples a data source to the data markers. Users can also create a spreadsheet using program-like text input, such as ws.Cells(“A1”).value=“Name”, where “A1” indicates the spreadsheet coordinates. In “Model Master”, the user employs a programming language to describe relationships among “objects”. The user has the option of placing any of the defined variables on a spreadsheet, using a command such as “profit at C”, indicating that the profit is to be displayed in column C of the spreadsheet. Although the language allows a user to specify relationships in a straightforward manner, such as “profit=income−outgoings”, the syntax for using such an equation in Model Maker is not well suited for a non-programmer. “Quantrix Modeler” and “Paradigm” provide for a less cumbersome input format, but each requires the user to create the general structure of the spreadsheet using a conventional spreadsheet graphic user interface.

Of particular note, each of these prior art systems require the user to conceptualize and/or create the two-dimensional structure within which results are computed and displayed, thereby requiring the creator of the business model to create the business model within the context and constraints of the form of the output that displays the results of the operation of the model.

This invention is premised on the observation that creating a description of a business model and creating a description of an output format to display the operation of this model are fundamentally different tasks. A financial business model, for example, is typically defined in terms of inflows and outflows, assets and liabilities, product lines, and so on; and, although a two-dimensional matrix is often a convenient form for displaying the results of the operation of such a model, a typical business professional does not describe the operation of a business in terms of a two dimensional matrix. For example, a business person's description of a business may include statements such as: “The company's profit equals its income less its expenses”; “Expenses include the costs of labor, material, and facilities”; “The company's products include printers, scanners, and plotters”; and so on. Such statements include a number of implicit assumptions and constraints. For example, it would generally be understood that the aforementioned profit would be based on the income and expenses associated with each of the products, that these incomes and expenses would be distributed over time, and so on. These implicit assumptions and constraints need to be included in a system that models the operation of the business and provides financial analyses, but requiring the creator of the business model to include all of these implicit assumptions into a description of the business is inconvenient, and, in most cases, unnecessary.

It is an object of this invention to ease the task of creating a business model, such as a model suitable for execution as a spreadsheet or set of spreadsheets. It is a further object of this invention to provide a modeling language that facilitates describing, comprehending, and auditing the business model. It is a further object of this invention to automate the creation of time-based models, such as spreadsheets.

These objects, and others, are achieved by a system and method that automates the creation of business models. The system and method include generators that generate data structures and models based on general assumptions regarding business models. A time series generator, for example, automatically generates a time series model suitable, for example, for creating a spreadsheet, even though the input description of the business model may be time-independent. In like manner, a cross-category generator creates a cross-category hierarchy, even though the business model is described using independent categorizations, such as market categories, product-line categories, organizational categories, and so on. By automatically replicating the description of variables and relationships among such time-series cross-category hierarchies based on general business model assumptions, the creator of the business model is freed of the tedium generally associated with creating a business model, and the occurrence of errors in the resultant models is substantially reduced. Further, the same input description of the business model can be used as the source of alternative models, depending upon the requirements of the intended application of the model.

### BRIEF DESCRIPTION OF THE DRAWINGS

The invention is explained in further detail, and by way of example, with reference to the accompanying drawings wherein:

FIG. 1 illustrates an example business model generation system in accordance with this invention.

FIG. 2A illustrates an example input for expressing relationships among variables in accordance with this invention, and FIGS. 2B and 2C illustrate the identification of dependent and independent variables based on these relationships.

FIGS. 3A, 3B, and 3C illustrate an example input for defining relationships, categories, and report formats, and FIGS. 3D and 3E illustrate the replication of variables over categories and time.

FIG. 4 illustrates an example flow diagram for replicating and defining variables.

FIG. 5 illustrates defined replicated variables corresponding to the example of FIGS. 3A-3B.

FIGS. 6A and 6B illustrate an example input for defining multiple categories and a report format based on the multiple categories, and FIGS. 6C and 6D illustrate a cross-category hierarchy and a replication of variables over this cross-category hierarchy to form a category-variable hierarchy.

FIG. 7 illustrates an example flow diagram for creating a cross category hierarchy.

FIG. 8 illustrates an example flow diagram for creating spreadsheets.

FIGS. 9A and 9B illustrate example spreadsheets.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

As noted above, this invention is premised on the observation that a typical business person describes a business using terms and expressions that are based on implicit assumptions and generalities that are applicable to all, or most businesses. While these assumptions and generalities need to be included in a business model that is suitable for processing on a computer system, or included within the processing application, burdening the business person with the requirement of encoding or otherwise describing such assumptions and generalities is time-consuming, and, in most cases, unnecessary. Similarly, a business person does not describe a business in terms of the output format that may be used to display the performance of the business, and thus coupling the definition of a business model to an output format, such as a spreadsheet format, is also an inefficient and/or ineffective means for creating the definition, even if a spreadsheet program is the intended target for the business model.

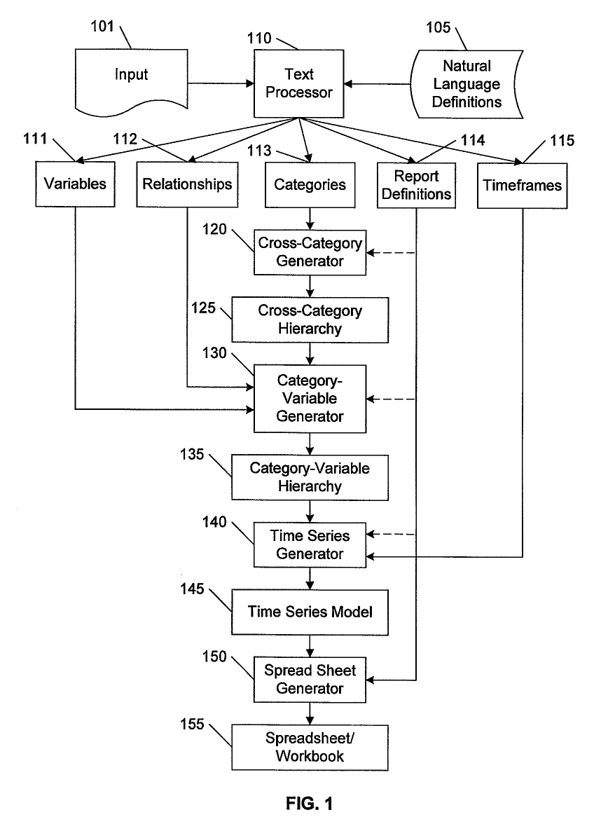

FIG. 1 illustrates an example block diagram of a business model generator in accordance with this invention. As noted above, for ease of understanding, this invention is described using the paradigm of a spreadsheet model, although other models may also be created. As illustrated, the business model generator includes a number of generators 120, 130, 140, and 150 that facilitate the generation of a business model, or models, based on assumptions and generalities which have been found to be common among most businesses. The input 111-115 to these generators 120-150 preferably correspond to items that a business person would use to describe the business.

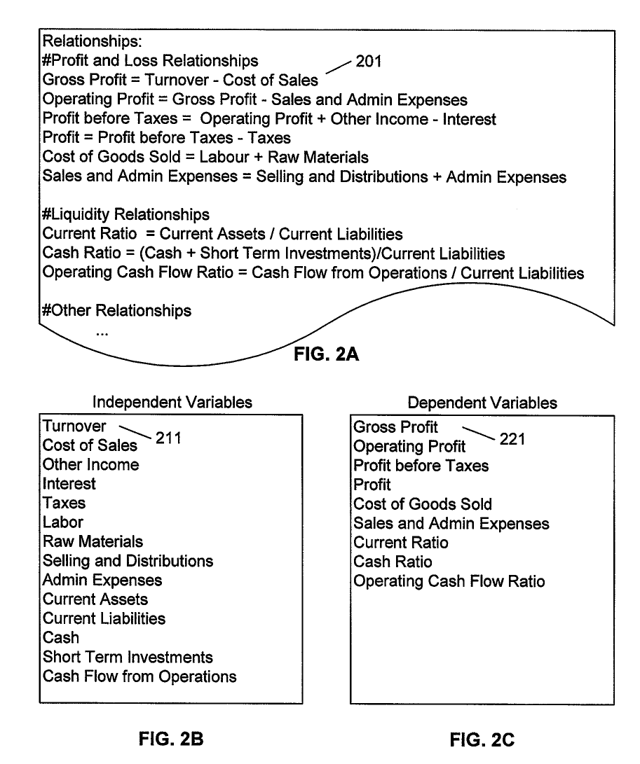

Example inputs 101 to the system of FIG. 1 include inputs that define the variables 111 that affect and/or characterize the business, or the operation of the business, and the relationships 112 among these variables. FIG. 2A illustrates an example input 101 for defining the variables 111 and relationships 112 of FIG. 1. Comment lines, indicated by a hash symbol (#) at the start of a line, are provided for the user's convenience for documenting the relationships. The first relationship 201 of FIG. 2A is a simple formula that defines the relationship between the variable “Gross Profits” and the variables “Turnover” and “Cost of Sales”. Although illustrated as being written as an equation, a preferred embodiment of the text processor 110 of FIG. 1 also supports a natural language interface, wherein the relationship could be given as: “Gross Profit is defined as the difference between Turnover and Cost of Sales,” or similarly flexible form, using a dictionary 105 of natural language terms, syntax, and other items that facilitate the determination of such relationships among variables.

In accordance with this invention, the text processor 110 analyzes and parses the input 101 to also classify the variables as dependent and independent variables, as illustrated in FIGS. 2B and 2C. This classification is used to determine whether a variable is a data item or determined by a combination of other data items, as discussed further below. As noted above, “Gross Profit” depends upon “Turnover” and “Cost of Sales”, and this is classified as a dependent variable 221. The defined relationships do not define the term “Turnover”, and thus “Turnover” is assumed to be an independent variable 211.

The input 101 of FIG. 1 also provides for an identification of “categories” 113 related to the business. For example, the categories may be geographic categories that are defined based on markets for products produced by the business, or based on supply chains for supporting the manufacture of products, or based on regional offices of the business, which may or may not be related to marketing or manufacturing, and so on. Similarly, the categories may be product lines, grouped by type of product, manufacturing source of the product, price of the product, and so on. The categories may also be based on the organization structure of the business, such as an engineering category, a manufacturing category, a marketing category, and so on. Basically, categories can be any combination of real or virtual partitions that facilitate analysis or management of the business, as defined by the user.

Although not required, per se, for creating a business model, the input 101 may also provide information regarding the reports 114 that facilitate analyses of the business, as well as timeframes 115 associated with such reports 114, or associated with other data collection or analysis functions related to the business. The timeframes 115 generally define a start time, such as a year, and a reporting or data collection period, such as monthly or quarterly. As contrast to conventional business modeling systems, the definition of reporting schemes and formats is substantially unrelated to the definitions of categories, variables, and relationships.

As would be evident to one of ordinary skill in the art, the input 101 may include a variety of inputs, as well as a variety of input devices. That is, for example, the input 101 that provides the relationships 112 may be a different file from the source of the category definitions; in like manner, a scanner may be used to create some of the input 101, and a keyboard used to create other parts of the input 101. Similarly, the input 101 could be created using a speech or handwriting recognition/transcription program, or the input 101 could be created as an output of another business application program, and so on.

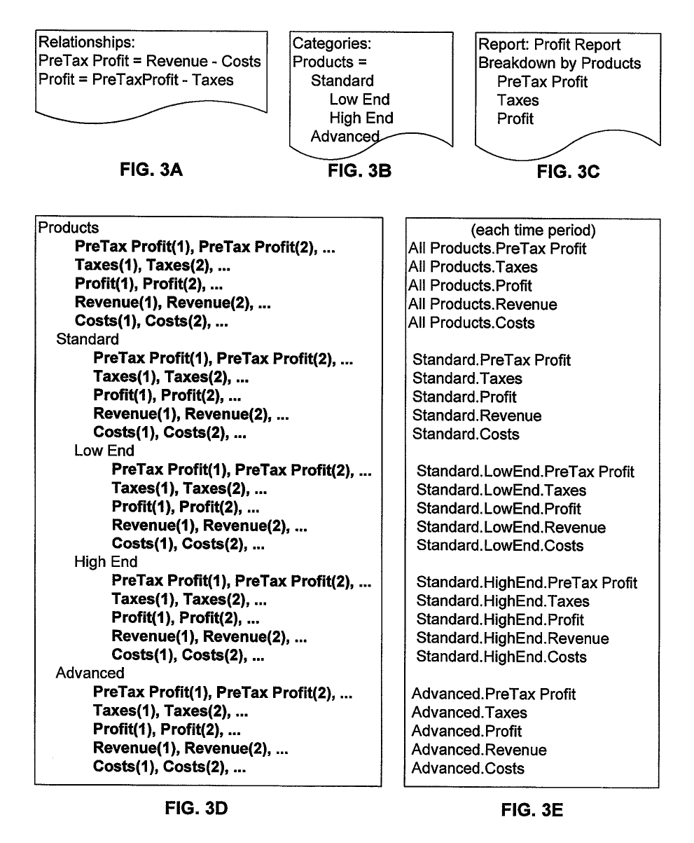

FIGS. 3A-3E illustrate how variables 111, relationships 112, categories 113, reports 114, and timeframes 115, are used to create a simple business model in accordance with aspects of this invention.

FIG. 3A illustrates relationships among five variables, PreTax Profit, Revenue, Costs, Taxes, and Profit; Revenue, Costs, and Taxes being independent variables, PreTax Profit and Profit being dependent upon these variables.

FIG. 3B illustrates an example input for defining a “Products” category (113 of FIG. 1) that includes “Standard” and “Advanced” products, wherein “Standard” products include “Low End” standard products and “High End” standard products. In a preferred embodiment of this invention, hierarchies are indicated by the use of indentation, as illustrated in FIG. 3A, wherein the indentation of “Low End” and “High End” under “Standard” indicates that these product types are subsets of standard products. Other techniques for indicating hierarchy, such as progressive dot-numbering (1. Products; 1.1. Standard; 1.1.1. Low End; 1.1.2. High End; 1.2. Advanced), nested parentheses (Products (Standard(Low End, High End), Advanced)), and so on, may also be used.

FIG. 3C illustrates an example input for defining a report (114 of FIG. 1) titled “Profit Report”. The organization of the report is defined by the “Breakdown by” directive, indicating that the report should be organized based on the example “Products” categorization of FIG. 3B. Thereafter, the variables of FIG. 3A that are to be included in the report, hereinafter termed “report variables”, are listed.

One of ordinary skill in the art will recognize that each of the example inputs of FIGS. 3A-3C are provided herein for illustrative purposes, and alternative input formats may be used to identify variables, relations, categories, and so on. In like manner, the inputs need not be partitioned as discrete segments as illustrated in FIGS. 3A-3C; for example, the definition of relationships illustrated in FIG. 3A, or the category illustrated in FIG. 3B could be included within the “report” input segment of FIG. 3C, to allow different relationships and categories to be created depending upon the elements or format desired in particular reports.

As noted above, a premise of this invention is that most business models are based on implicit assumptions or generalities. For example, the profit of the business described by the relationships and categories of FIGS. 3A and 3B can be expected to be dependent upon the profit of the products, which is dependent upon the profit of the standard products and the advanced products, and the profit of the standard products is dependent upon the profit of the low end standard products and the high end standard products. In like manner, these profits can be expected to be distributed over time.

Referring to FIG. 1, a category-variable generator 130 is configured to replicate variables over categories to form a category-variable hierarchy 135, and a time series generator 140 is configured to replicate the category-variable hierarchy 135 over time to form a time-series model 145.

FIG. 3D illustrates an example replication of variable over categories, and variable-categories over time. Each branch and node of the category hierarchy of FIG. 3B contains an instance of each of the five variables of FIG. 3A for each time interval (1), (2), etc. That is, based on the inputs of FIGS. 3A and 3B, a model of the assumed parameters of interest of the described business is automatically created.

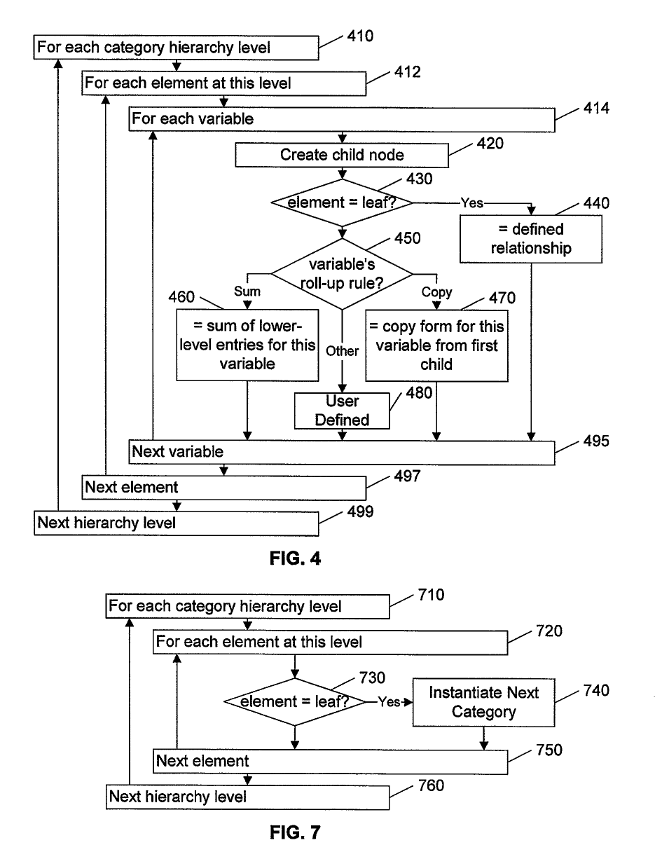

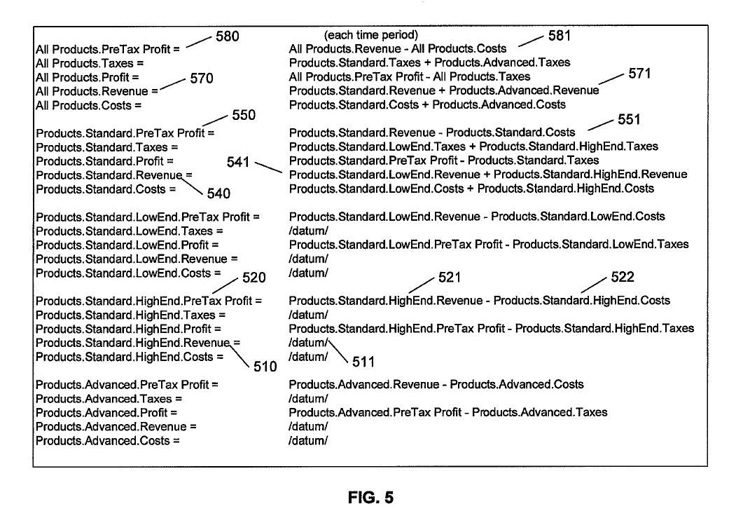

FIG. 3E illustrates an example set of variables created for this model for each time period, as would appear, for example, as a column of a matrix of variables for each time period. The definitions of each these variables are developed from the relationships illustrated in FIG. 3A, as discussed further below with regard to FIGS. 4 and 5.

FIG. 4 illustrates an example flow diagram for creating a category hierarchy, and for defining the instantiated variables throughout this hierarchy. For-next loops are shown in FIG. 4 for ease of illustration; one of ordinary skill in the art will recognize that other techniques for traversing a hierarchical structure may also be used. The loop 410-499 processes each category hierarchy level, and the loop 412-497 processes each element; preferably the processing of the hierarchy is bottom-up, as will be evident from the description below.

The loop 414-495 instantiates each defined variable at each branch or leaf node of the category hierarchy. Depending upon the complexity of the modeled system, a subset of the defined variables may be instantiated, for efficient processing. For example, in some situations, only those defined variables that are required to satisfy the target report requirements may be instantiated (this dependency is illustrated by the dashed arrow between the report definitions 114 and the category-variable generator 130 in FIG. 1).

For each variable to be instantiated, a child node to the current element of the category hierarchy is created, at 420. An identifier/name of this node is preferably created as a concatenation of the upper category hierarchy level (e.g. “Standard”), the category element name (e.g. “HighEnd”), and the variable name (e.g. “Revenue”), to form an identifier such as “Standard.HighEnd.Revenue”, as illustrated in FIG. 3E. To assure uniqueness, particularly when multiple categories may be used, the category name is also preferably included in the identifier, as illustrated in FIG. 5 (e.g. “Products.Standard.HighEnd.Revenue”). At the top level of the category hierarchy the identifier “All”+category-name (e.g. “All Products”) is used, for ease of identification of composites of each category. Other techniques for uniquely identifying each instantiation of a variable may also be used, although the concatenation of hierarchy-element-variable names is particularly well suited for ease of understanding and debugging. The value associated with each child node is defined as detailed below.

If, at 430, the category element is a leaf node in the hierarchy, the value of the child node is defined based on the type of variable (111 of FIG. 1). If the variable is an independent variable, then its value will be a datum that is provided as an input to the model; if the variable is a dependent variable, then its value will be its defined relationship to the independent variables or other dependent variables (112 of FIG. 1). With reference to FIG. 5, for example, at the leaf element HighEnd of the Standard—Products hierarchy, the instantiation of the Revenue variable, Products.Standard.HighEnd.Revenue 510 is defined as a datum 511, because Revenue is an independent variable of the model defined by the relationships of FIG. 3A. Conversely, the PreTax Profit variable is defined as a dependent variable in FIG. 3A (“PreTax Profit=Revenue−Costs”). Applying this relationship, the instantiation of Products.Standard.HighEnd.PreTax Profit 520 is defined as instantiated variable “Products.Standard.HighEnd.Revenue” 521 minus the instantiated variable “Products.Standard.HighEnd.Costs” 522. Similar instantiations of the defined variables occurs at each of the other category leaf nodes (Low End and Advanced).

It is significant to note that in accordance with this aspect of the invention, the relationship among variables is retained in each instantiation. That is, for example, wherever the variable “Profit” is instantiated within a category, the “=PreTaxProfit−Taxes” relationship is instantiated; wherever the “PreTaxProfit” variable is instantiated, the “=Revenue−Costs” relationship is instantiated; and so on. Alternatively, higher-level instantiations of a variable could include a composite of the lower-level instantiations, such as “Standard.Profit=LowEnd.Profit+HighEnd.Profit”, but such an instantiation does not preserve the relationship among variables at each category level, which could limit the applications for which the resultant category-variable hierarchy 135 or time series model 145 can be used.

If, at 430, the category element is a branch node (i.e. not a leaf node), the variable's “roll-up rule” is used to define the instantiated variables at these higher levels of the category hierarchy. Preferably, the roll-up rule defines a process or procedure for creating a composite of the instantiations at a lower level of the hierarchy. This composite is generally a value that characterizes the multiple lower level instantiations by a single value, such as a summary statistic or other characteristic value. By default, the roll-up rule for instantiations based on independent variables is a “sum” rule, and the roll-up rule for instantiations based on dependent variables is a “copy from child” rule.

A “sum” roll-up rule defines the instantiation of the variable at each branch node as the sum of the instantiations of the variable at each of the child nodes of the branch node. As illustrated in FIG. 5, at the category branch nodes (All Products and Standard), the definition of the instantiation of the Revenue independent variable (Products.Standard.Revenue 540, All Products.Revenue 570) is the sum 541, 571 of the instantiations of the variable at each of the child nodes beneath the branch node. That is, the instantiation of each variable with a “sum” roll-up rule at the “Standard” branch of the hierarchy is defined as the sum of the instantiations of the variable at the “LowEnd” and “HighEnd” nodes of this branch. In like manner, the instantiation of each variable with a “sum” roll-up rule at the “All Products” branch of the hierarchy is defined as the sum of the instantiations of the variable at the “Standard” and “Advanced” nodes of the “All Products” branch.

A “copy” roll-up rule defines the instantiation of the variable at each branch node as a corresponding copy of the instantiation of the variable at the first child node of the branch node. As illustrated in FIG. 5, the instantiation 550 of the PreTax Profit variable at the “Standard” branch of the hierarchy is a copy 551 of the relationship (“Revenue−Costs”) of the PreTax Profit variable at the “LowEnd” child node, and the instantiation 580 at the “All Products” branch is a copy 581 of the same relationship.

In a preferred embodiment, other roll-up rules may be applied, either by expanding the default classifications, or by allowing user-defined rules. For example, if one of the defined variables corresponds to an average of other variables, or a peak value (minimum, maximum) of other variables, the roll-up rule for such a variable may also be an average, or a peak value. In like manner, if a variable is used to hold a constant, such as an interest rate, a text field, and so on, the roll-up rule may be a literal copy from level to level. Any number of techniques may be used to associate roll-up rules with variable types, and/or to define variable types. In the examples of FIGS. 2A and 3A, each of the variables is assumed to be each of one of two types, independent and dependent. In a preferred embodiment, qualifiers may be added to the default variable-typing, such as “where xx is a constant”. In like manner, terms in the relationship could be used to define different default roll-ups, such as the use of an average function to define a relationship.

As illustrated in FIG. 5, a fairly substantial and complete model, suitable for use in a variety of computer applications, is provided based on a minimum amount of input (FIGS. 3A, 3B), and a set of generally applicable assumptions regarding typical businesses. The model of FIG. 5 is easily replicated across time periods by associating each of the instantiated variables to each time period, via the time series generator 140 of FIG. 1.

Because each of the category elements at each level of the hierarchy includes substantiated ‘roll-up’ values, the creation of reports that are organized based on the hierarchy is straightforward, so that report directives such as “subtotal by products type” can be easily accommodated. In like manner, reports based on time-frames can also be easily provided by including such requirements in the time-series generator 140, as illustrated by the dashed arrow between the reports definition 114 and the time series generator 140. For example, in a preferred embodiment, key terms such as day, week, month, quarter, year, etc. are understood, and the user can provide directives such as: get weekly inputs, report monthly outputs, subtotal per quarter, average per year, and so on.

The example of FIGS. 3A-3C and FIG. 5 illustrate the automatic replication of variables over a single category. In accordance with another aspect of this invention, multiple categories may be defined in the category input (113 of FIG. 1), and the resultant business model will reflect these multiple categories, again using implied assumptions regarding business models.

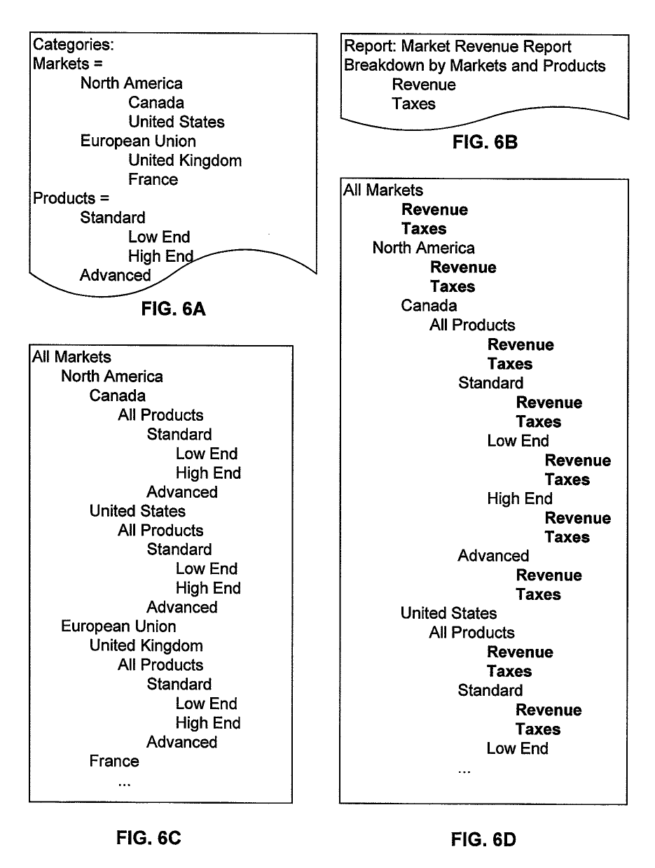

FIG. 6A illustrates a definition of categories that includes two independent categories: “Markets” and “Products”. In this example model, the Markets include a “North America” market and a “European Union” market. The North America market includes “Canada” and “United States”, and the European Union market includes “United Kingdom” and “France”. The Products category is the same as illustrated in FIG. 3B, and includes Low End Standard Products, High End Standard Products, and Advanced Products.

FIG. 6B illustrates an example report definition, which calls for a breakdown by “Markets and Products”. In accordance with this aspect of the invention, a report calling for a multiple category breakdown implies that underlying model is based on, or can be based on, a combination of these categories. That is, for example, it can be assumed that each product type is marketed through each the markets. As illustrated in FIG. 1, to automate the process of creating a business model based on such assumptions, a cross-category generator 120 is provided to create such a hierarchical combination of categories 125. Although every possible cross-category combination could be generated (e.g. products-by-markets and markets-by-products), in a preferred embodiment of this invention, the report definitions 114 are used to define the desired form of the combination of categories, as illustrated by the dashed arrow between the definitions 114 and the generator 120. In the example of FIG. 6B, “Breakdown by Markets and Products”, it is assumed that the first named category (Markets) is the upper-level hierarchy, and each subsequent category is the next-lower-level hierarchy. That is, in the example of FIG. 6B, each market element includes a hierarchy of products. Had the example been “Breakdown by Products and Markets”, each product type would include a hierarchy of markets. Other techniques may also be used to identify the order of cross-category replication, as would be evident to one of ordinary skill in the art.

FIG. 7 illustrates an example flow diagram for creating a cross-category hierarchy, and FIG. 6C illustrates the results of such a process being applied to the example category definitions of FIG. 6A.

The loops 710-760 and 720-750 traverse the hierarchy until a leaf element is found, at 730. When each leaf element is found, the next category is instantiated; that is, each leaf element of an upper level category will include a full instantiation of the next level category. In FIG. 6A, for example, “Canada”, “United States”, “United Kingdom”, and “France” are leaf elements of the “Markets” category. In FIG. 6C, the example cross-category hierarchy includes a full instantiation 610 of the “Products” category at each of these leaf elements of the “Markets” category.

The instantiation of a lower level category at a leaf element creates a new set of leaf elements, and if there are other categories being replicated, each lower level category will be instantiated at each newly created leaf element in the resultant cross-category hierarchy until the only leaf elements in the hierarchy are the leaf elements of the lowest level category.

As illustrated in FIG. 1, the cross-category hierarchy 125 forms the input to the category-variable generator 130, discussed above. Note that if there is only one category, as in the example of FIG. 3B, the cross-category hierarchy 125 is merely the single category hierarchy, as used in the example of FIG. 3D-3E.

The category-variable generator 130 of FIG. 1 operates as detailed above to create the category-variable hierarchy 135, except that the category hierarchy corresponds to the created cross-category hierarchy. FIG. 6D illustrates the replication of variables “Revenue” and “Taxes” across the cross-category hierarchy of FIG. 6C. Note that the variables are instantiated at each branch and leaf node of the cross-category hierarchy. The definitions of each of these instantiations are created as detailed above with regard to the example flow diagram of FIG. 4. That is, at each leaf node of the cross-category hierarchy, the instantiations are as defined by the relationship definitions, and at each branch node, the instantiations conform to the corresponding roll-up rule for each variable.

In like manner, the time series generator 140 provides a time series model 145 by replicating each leaf node of the category-variable hierarchy 130 over each time period. The timeframes definitions 115 define the timeframes to be used for this replication. For example, the timeframes definitions 115 may specify “Quarterly, five years, beginning in 2004”, “Monthly, one year”, “Annual, 2003-2007”, and so on. Specifically, the timeframes parameters should include a start time (relative or absolute), a time increment, and an end time (or number of time increments); preferably, a default set of parameters are provided (e.g. year 0, quarterly, 3 years), and the user input 101 allows for a replacement of one or more of these default parameters. In the context of the business model, the replication is per-time-period, for the total number of time-periods.

Optionally, the report definition parameters 114 may be used to further define or refine these timeframe parameters; for example, the data collection (input) timeframe may be weekly or monthly, but the reporting timeframe may be quarterly or annually. In such an embodiment, a different replication may be performed for input (independent) variables and output (dependent) variables; or, each replication can occur at the shorter time period and marked accordingly as an input period, output period, or both.

In a preferred embodiment, either the category-variable hierarchy 135 or the time series model 145 is used as the model that defines the business, depending upon whether the model definition is time-independent or time-dependent.

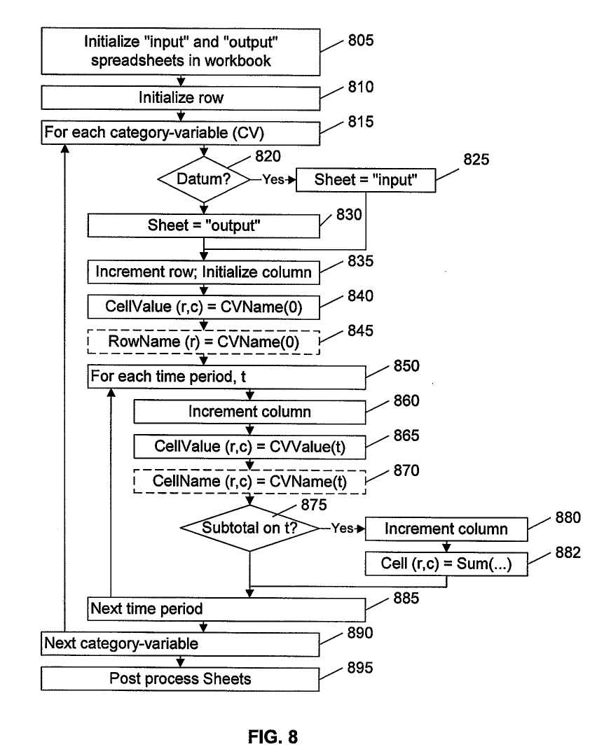

FIG. 8 illustrates an example flow diagram for creating spreadsheets from a business model in accordance with this invention. In this example, it is assumed that the model is time-dependent, and thus the input corresponds to a time series model (145 of FIG. 1).

In a preferred embodiment, two spreadsheets are created, an input spreadsheet and an output spreadsheet. In the vernacular of spreadsheets, the input spreadsheet is commonly termed the “assumptions” spreadsheet, and is configured to contain the data that is used to produce the output spreadsheet. In the terms of this application, the input spreadsheet is configured to contain values for the independent variables, and the output spreadsheet is configured to display the determined values of the report variables, which may include both independent and dependent variables. Other configurations may also be used; for example, an intermediate spreadsheet may be created to provide an area where dependent variables that are not report variables (i.e. are not variables expressly called out to be reported) are determined. In the model illustrated in FIG. 3A, for example, a user may request a report that includes the variable “Profit”, but not the variable “PreTax Profit”. However, the system is configured to recognize that the variable “Profit” is dependent upon the variable “PreTax Profit”, and will include a determination of the variable “PreTax Profit”. Such ‘intermediate variables’ that are not report variables, per se, may be placed in a different spreadsheet from either the input or output spreadsheets, so as not to clutter the output spreadsheet.

At 805, the two (or more) spreadsheets are initialized. Such an initialization may include providing “title” information, such as the name of the report, the originator, the date, and so on, as well as the headings for each column, using techniques common to one of ordinary skill in the art. At 810, an index to the last-used row is determined, based on the number of rows consumed by the title information, the column headings, and so on.

The loop 815-890 steps through each category-variable CV in the input model (145 of FIG. 1). If, at 820, the category-variable is defined as a datum, the “input” spreadsheet becomes the target spreadsheet; otherwise, the “output” spreadsheet is the target spreadsheet.

At 835, the row index is incremented, and the column index is initialized (typically to column 1). At 840, the value of the cell at the initial column of the current row is the name of variable. In the example of FIG. 5, the value of the initial column of the initial row will be “All Products.PreTax Profit” (580).

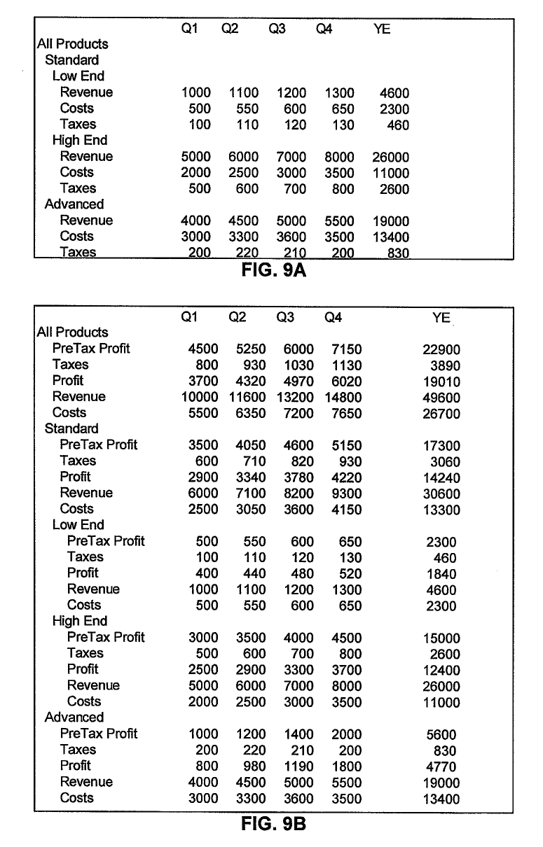

Optionally, as each new set of category-variables in the hierarchy is processed, the block 845 can be configured to create ‘non-data’ rows in the spreadsheet to illustrate the hierarchy, as illustrated in FIGS. 9A-B. In the example spreadsheets of FIGS. 9A-B, when the “All Products” identifier of the hierarchy is identified, a row with a name entry of “All Products” is created, and the next row created, corresponding to the first category-variable of this hierarchy. Because the hierarchical name prefix “All Products” is displayed on the previous row, the value assigned to the cell can be the category-variable name less the hierarchical name prefix. (I.e. “PreTax Profit” in FIG. 9B, in lieu of “All Products.PreTax Profit”).

The blocks 845 and 870 are optionally selected, based on the particular target spreadsheet program. In Excel and other spreadsheets, naming a row allows for automatic cell-index referencing, wherein if reference is made at cell (m,n) to a named row, the system automatically assumes that the column index to the referenced cell in the named row is “n”. That is, if cell (r1,c1) references a named row “All Products.PreTax Profit” that is defined as row r2, the reference is automatically determined to be to cell (r2,c1). In such a system, block 840 is used to name the current row as the name of the category-variable. As would be evident to one of ordinary skill in the art, if the syntax required by the target spreadsheet does not conform to the syntax used for category-variable names, the category-variable name is transformed to comply with the required syntax. For example, if the spreadsheet program does not allow spaces in a name of a row, the system will be configured to remove spaces in the category-variable name to provide a properly formed row name.

The loop 850-885 steps though each time period called for in the report, to create a column corresponding to each time period.

At 860, the column index is incremented, and at 865, the cell at the current row and column index is given the value of the current category-variable CV. That is, using the example of FIG. 5, each cell is given the equation on the right hand side of the sheet as its value.

Note that the equations are provided for each time period. That is, the first equation 581 is actually “All Products.Revenue(t)−All Products.Costs(t)”, where t is the time period. As noted above, if the target spreadsheet program automatically assigns column indices to named rows, the time period reference to each variable in each equation is not required. That is, in the example of FIG. 9B, if the “Revenue” (6^{th}) row is named “All Products.Revenue”, and the “Costs” (7^{th}) row is named “All Products.Costs, an entry of ”=All Products.Revenue−All Products.Costs” at column 2 will automatically be interpreted as “=All Products.Revenue(column 2)−All Products.Costs(column 2)”, and when executed by the spreadsheet program, will display a value equal to Cell(6,2)−Cell(7,2).

If explicit time-period/column referencing is used, each cell across the columns of the variable are expressly named, including the time or column reference, at 870. That is, the first “Revenue” entry at column 2 of the example of FIG. 9B is named “All Products.Revenue(1)”, the “Costs” entry at column 2 is named “All Products.Costs(1)”, and the value of the “PreTax Profit” entry at column 2 is “=All Products.Revenue(1)−All Products.Costs(1)”. In like manner, the next column's value would be “=All Products.Revenue(2)−All Products.Costs(2)”, and the corresponding second revenue and cost cells would be named “All Products.Revenue(2)” and “All Products.Costs(2)” respectively. One of ordinary skill in the art will recognize that although this explicit per-period reference increases the size of the resultant spreadsheet description, its use allows this process to be used regardless of whether the target spreadsheet program provides for an automatic column-reference determination. It also allows the form of the variety of spreadsheets to differ (e.g. the source of the input spreadsheet need not be the same as the form of the output spreadsheet). Additionally, the explicit references facilitate verification of the model, not being reliant on an identical column structure being maintained across multiple spreadsheets, and can simplify the merging of differently formed input spreadsheets.

In a preferred embodiment of this invention, the report definition (114 in FIG. 1) allows a user to specify an order of providing subtotals corresponding to an implicit or explicitly defined hierarchy of time. For example, the input 101 could include a directive such as “Subtotal by Quarter”, or “Annual Subtotals”, and so on. At 875, the time period is checked to determine whether a time-based subtotal is required at this time, and if so, a column is added, at 880, and populated with the required summation formula, at 882. For example, if the reporting period is monthly and a subtotal is required quarterly, the summation formula will provide for the summation of the last three columns for each category-variable row. In lieu of inserting a summary column immediately following the columns being summarized, the summary columns could be grouped together, so that, for example, the report would show twelve contiguous columns of monthly figures, followed by four contiguous columns of quarterly summaries. In a preferred embodiment, a hierarchy of subtotaling functions is supported, so that, for example, the report can provide both quarterly and yearly subtotals.

At 895, the spreadsheet is post-processed, to provide an efficient and effective display of the input and/or output sheets. For example, the output sheet will likely include a variety of the aforementioned ‘intermediate values’ that are not explicitly identified as report variables. In a preferred embodiment, the post-processing at 895 includes ‘hiding’ such variables, by including filters in the resultant spreadsheets.

Also in a preferred embodiment of this invention, the post-processing 895 includes “locking” the fields created by the spreadsheet, to assure its integrity and to prevent inadvertent changes or erasures. Such locking is particularly valuable for corporate applications, wherein, for example, the corporation provides audited relationships and a controlled database of input assumptions; by locking the fields created based on these audited relationships, the need to audit each resultant spreadsheet is virtually eliminated.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although each of the above examples included the use of a combination of generators 120, 130, 140, 150 one of ordinary skill in the art will recognize that each generator can be used independently to replicate variables within each dimension. Similarly, each of the generators 120, 130, 140, 150 are illustrated as receiving a single input set 113, 125, 135, 145 for processing, one of ordinary skill in the art will recognize that these input sets 113, 125, 135, 145 could include multiple sets, each of these sets optionally being generated independently. For example, the time series generator 140 may create a time series model 145 based on multiple category-variable hierarchies 135; or, the spreadsheet generator 150 may create a spreadsheet 155 based on multiple time series models 145; and so on.

These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

We claim:

1. A system comprising:
an input system that is configured to accept as input one or more time-independent relationships among variables, and one or more categories,
a time series generator that is configured to automatically create a time series model having a plurality of time periods, based on the categories and the relationships among variables,
wherein
the time series model includes an instantiation of one or more of the variables within each category within each time period.

2. The system of claim 1, further including
a spread sheet generator that is configured to create one or more spreadsheets based on the time series model.

3. The system of claim 2, wherein
the spread sheet generator is configured to create the one or more spreadsheets based on one or more other time series models.

4. The system of claim 2, wherein
the spread sheet generator is configured to:
provide names to cells in the spreadsheet corresponding to the instantiation of each variable within each category, and
provide values to the cells based on the relationships among the variables and the names corresponding to the instantiations.

5. The system of claim 1, wherein
the time periods are arranged in a time hierarchy, and
the instantiation of each variable within each time period conforms to the hierarchy.

6. The system of claim 5, wherein
the instantiation of each variable at an upper level of the time hierarchy is configured to provide a value of the instantiation corresponding to a composite of instantiations at a lower level of the time hierarchy.

7. The system of claim 6, wherein
the composite includes one of: a summation, an average, and a peak value.

8. The system of claim 1, wherein
the categories are arranged in a hierarchy, and
the instantiation of each variable within each category conforms to the hierarchy.

9. The system of claim 8, wherein
the instantiation of each variable at an upper level of the hierarchy is configured to provide a value of the instantiation corresponding to a composite of instantiations at a lower level of the hierarchy.

10. The system of claim 9, wherein
the composite includes one of: a summation, an average, and a peak value.

11. The system of claim 1, wherein
the categories include a first set of categories and a second set of categories,
the system further includes
a cross-category generator that is configured to instantiate the second set of categories at each leaf node of the first set of categories to form a cross-category hierarchy, and
the instantiation of each variable within each category conforms to the cross-category hierarchy.

12. The system of claim 1, wherein
the input system is also configured to identify report variables from among the variables, and
the time series model includes instantiations of each of the variables that affect one or more of the report variables, based on the relationships among variables.

13. The system of claim 12, further including
a spreadsheet generator that is configured to:
create an output spreadsheet that provides a display of values corresponding to the variables,
filter one or more fields of the output spreadsheet dependent upon the report variables.

14. The system of claim 1, wherein
the input system is configured to classify each of the variables as either dependent or independent variables, based on the relationships, and
a value associated with each instantiation of the variable is dependent upon whether the variable is dependent or independent.

15. The system of claim 14, further including
a spreadsheet generator that is configured to create:
an input spreadsheet that facilitates collection of data corresponding to each independent variable, and
an output spreadsheet that provides a display of values corresponding to one or more of the dependent variables, based on the input spreadsheet.

16. The system of claim 14, further including
a spreadsheet generator that is configured to:
create an output spreadsheet that provides a display of values corresponding to one or more of the dependent variables, based on data associated with the independent variables, and
lock one or more fields of the output spreadsheet to ensure that the values displayed corresponding to each dependent variable conforms to the relationships among variables.

17. The system of claim 1, wherein
the input system includes a natural-language dictionary that facilitates input of the relationships among variables in a natural-language form.

18. The system of claim 1, wherein
the input system includes at least one of:
a document image to text transformation engine;
a handwriting to text transformation engine; and
a speech to text transformation engine.

19. A system comprising:
an input system that is configured to accept as input one or more relationships among variables, and at least a first set of categories and a second set of categories,
a cross-category generator that is configured to automatically create a cross-category model, based on the first and second sets of categories, and
a category-variable generator that is configured to create a category-variable model based on the cross-category model and the relationships among variables
wherein
the category-variable model includes an instantiation of one or more of the variables within each cross-category of the cross-category model.

20. The system of claim 19, further including
a spread sheet generator that is configured to create one or more spreadsheets based on the category-variable model.

21. The system of claim 20, wherein
the spread sheet generator is configured to create the one or more spreadsheets based on one or more other category-variable models.

22. The system of claim 20, wherein
the spread sheet generator is configured to:
provide names to cells in the spreadsheet corresponding to the instantiation of each variable within each cross-category, and
provide values to the cells based on the relationships among the variables and the names corresponding to the instantiations.

23. The system of claim 20, wherein
the spread sheet generator is configured to create sub-total fields, based on the first and second sets of categories.

24. The system of claim 19, wherein
the first and second sets of categories are arranged in a hierarchy, and
the instantiation of each variable within each cross-category conforms to the hierarchy.

25. The system of claim 24, wherein
the instantiation of each variable at an upper level of the hierarchy is configured to provide a value of the instantiation corresponding to a composite of instantiations at a lower level of the hierarchy.

26. The system of claim 25, wherein
the composite includes one of: a summation, an average, and a peak value.

27. The system of claim 19, wherein
the cross-category generator is configured to instantiate the second set of categories at each leaf node of the first set of categories to form the cross-category model.

28. The system of claim 19, wherein
the input system is also configured to identify report variables from among the variables, and
the category-variable model includes instantiations of each of the variables that affect one or more of the report variables, based on the relationships among variables.

29. The system of claim 28, further including
a spreadsheet generator that is configured to:
create an output spreadsheet that provides a display of values corresponding to the variables,
filter one or more fields of the output spreadsheet dependent upon the report variables.

30. The system of claim 19, wherein
the input system is configured to classify each of the variables as either dependent or independent variables, based on the relationships, and
a value associated with each instantiation of the variable is dependent upon whether the variable is dependent or independent.

31. The system of claim 30, further including
a spreadsheet generator that is configured to create:
an input spreadsheet that facilitates collection of data corresponding to each independent variable, and
an output spreadsheet that provides a display of values corresponding to one or more of the dependent variables, based on the input spreadsheet.

32. The system of claim 30, further including
a spreadsheet generator that is configured to:
create an output spreadsheet that provides a display of values corresponding to one or more of the dependent variables, based on data associated with the independent variables, and
lock one or more fields of the output spreadsheet to assure that the values displayed corresponding to each dependent variable conforms to the relationships among variables.

33. The system of claim 19, wherein
the input system includes a natural-language dictionary that facilitates input of the relationships among variables in a natural-language form.

34. The system of claim 19, wherein
the input system includes at least one of:
a document image to text transformation engine;
a handwriting to text transformation engine; and
a speech to text transformation engine.

35. A system comprising:
an input system that is configured to accept as input one or more time-independent relationships among variables, and a timeframe,
a time series generator that is configured to automatically create a time series model having a plurality of time periods, based on the timeframe and the relationships among variables,
wherein
the time series model includes an instantiation of one or more of the variables within each time period of the plurality of time periods corresponding to the timeframe.

36. The system of claim 35, further including
a spread sheet generator that is configured to create one or more spreadsheets based on the time series model.

37. The system of claim 36, wherein
the spread sheet generator is configured to create the one or more spreadsheets based on one or more other time series models.

38. The system of claim 36, wherein
the spread sheet generator is configured to:
provide names to cells in the spreadsheet corresponding to the instantiation of each variable, and
provide values to the cells based on the relationships among the variables and the names corresponding to the instantiations.

39. The system of claim 35, wherein
the time periods are arranged in a time hierarchy, and
the instantiation of each variable within each time period conforms to the hierarchy.

40. The system of claim 39, wherein
the instantiation of each variable at an upper level of the time hierarchy is configured to provide a value of the instantiation corresponding to a composite of instantiations at a lower level of the time hierarchy.

41. The system of claim 40, wherein
the composite includes one of: a summation, an average, and a peak value.

42. The system of claim 35, wherein
the input system is also configured to identify report variables from among the variables, and
the time series model includes instantiations of each of the variables that affect one or more of the report variables, based on the relationships among variables.

43. The system of claim 42, further including
a spreadsheet generator that is configured to:
create an output spreadsheet that provides a display of values corresponding to the variables,
filter one or more fields of the output spreadsheet dependent upon the report variables.

44. The system of claim 35, wherein
the input system is configured to classify each of the variables as either dependent or independent variables, based on the relationships, and
a value associated with each instantiation of the variable is dependent upon whether the variable is dependent or independent.

45. The system of claim 44, further including
a spreadsheet generator that is configured to create:
an input spreadsheet that facilitates collection of data corresponding to each independent variable, and
an output spreadsheet that provides a display of values corresponding to one or more of the dependent variables, based on the input spreadsheet.

46. The system of claim 44, further including
a spreadsheet generator that is configured to:
create an output spreadsheet that provides a display of values corresponding to one or more of the dependent variables, based on data associated with the independent variables, and
lock one or more fields of the output spreadsheet to ensure that the values displayed corresponding to each dependent variable conforms to the relationships among variables.

47. The system of claim 35, wherein
the input system includes a natural-language dictionary that facilitates input of the relationships among variables in a natural-language form.

48. The system of claim 35, wherein
the input system includes at least one of:
a document image to text transformation engine;
a handwriting to text transformation engine; and
a speech to text transformation engine.

49. A system comprising:
an input system that is configured to accept as input one or more relationships among variables, and a set of categories arranged in a hierarchy, and
a category-variable generator that is configured to create a category-variable model based on the cross-category model and the relationships among variables
wherein
the category-variable model includes one or more instantiations corresponding to one or more of the relationships among variables at a plurality of levels of the hierarchy of categories.

50. The system of claim 49, further including
a spread sheet generator that is configured to create one or more spreadsheets based on the category-variable model.

51. The system of claim 50, wherein
the spread sheet generator is configured to create the one or more spreadsheets based on one or more other category-variable models.

52. The system of claim 50, wherein
the spread sheet generator is configured to:
provide names to cells in the spreadsheet corresponding to the instantiation of the one or more relationships among variables, and
provide values to the cells based on the relationships among the variables and the names corresponding to the instantiations.

53. The system of claim 50, wherein
the spread sheet generator is configured to create composite fields, based on the hierarchy.

54. The system of claim 53, wherein
the composite fields include one of: a summation, an average, and a peak value.

55. The system of claim 49, wherein
the input system is also configured to identify report variables from among the variables, and
the category-variable model includes instantiations of each of the variables that affect one or more of the report variables, based on the relationships among variables.

56. The system of claim 55, further including
a spreadsheet generator that is configured to:
create an output spreadsheet that provides a display of values corresponding to the variables,
filter one or more fields of the output spreadsheet dependent upon the report variables.

57. The system of claim 49, wherein
the input system is configured to classify each of the variables as either dependent or independent variables, based on the relationships, and
the one or more instantiations corresponding to the one or more of the relationships among variables is dependent upon whether the variable is dependent or independent.

58. The system of claim 57, further including
a spreadsheet generator that is configured to create:
an input spreadsheet that facilitates collection of data corresponding to each independent variable, and
an output spreadsheet that provides a display of values corresponding to one or more of the dependent variables, based on the input spreadsheet.

59. The system of claim 57, further including
a spreadsheet generator that is configured to:
create an output spreadsheet that provides a display of values corresponding to one or more of the dependent variables, based on data associated with the independent variables, and
lock one or more fields of the output spreadsheet to assure that the values displayed corresponding to each dependent variable conforms to the relationships among variables.

60. The system of claim 49, wherein
the input system includes a natural-language dictionary that facilitates input of the relationships among variables in a natural-language form.

61. The system of claim 49, wherein
the input system includes at least one of: a document image to text transformation engine; a handwriting to text transformation engine; and a speech to text transformation engine.

62. The system of claim 49, wherein
each of the one or more instantiations occurs at a leaf node of the hierarchy.

63. The system of claim 62, wherein
the category-variable model includes one or more other instantiations corresponding to one or more composites of instantiations at a lower-level of the hierarchy.

64. The system of claim 63, wherein
each of the one or more other instantiations occurs at a branch node of the hierarchy.

65. The system of claim 63, wherein
the composite includes at least one of: a sum, an average, and a peak value.

66. A method comprising:
receiving one or more time-independent relationships among variables, and one or more categories,
automatically creating a time series model having a plurality of time periods, based on the categories and the relationships among variables, including instantiation of one or more of the variables within each category within each time period of the time series model.

67. The method of claim 66, further including
creating one or more spreadsheets based on the time series model.

68. The method of claim 67, wherein
creating the one or more spreadsheets is also based on one or more other time series models.

69. The method of claim 67, wherein
creating the spread sheet includes:
providing names to cells in the spreadsheet corresponding to the instantiation of each variable within each category, and
providing values to the cells based on the relationships among the variables and the names corresponding to the instantiations.

70. The method of claim 66, wherein
the time periods are arranged in a time hierarchy, and
the instantiation of each variable within each time period conforms to the hierarchy.

71. The method of claim 70, wherein
the instantiation of each variable at an upper level of the time hierarchy is configured to provide a value of the instantiation corresponding to a composite of instantiations at a lower level of the time hierarchy.

72. The method of claim 71, wherein
the composite includes one of: a summation, an average, and a peak value.

73. The method of claim 66, wherein
the categories are arranged in a hierarchy, and
the instantiation of each variable within each category conforms to the hierarchy.

74. The method of claim 66, wherein
the instantiation of each variable at an upper level of the hierarchy is configured to provide a value of the instantiation corresponding to a composite of instantiations at a lower level of the hierarchy.

75. The method of claim 74, wherein
the composite includes one of: a summation, an average, and a peak value.

76. The method of claim 66, wherein
the categories include a first set of categories and a second set of categories,
the method further includes
instantiating the second set of categories at each leaf node of the first set of categories to form a cross-category hierarchy, and
the instantiation of each variable within each category conforms to the cross-category hierarchy.

77. The method of claim 66, further including
receiving an identification of report variables from among the variables, and
the time series model includes instantiations of each of the variables that affect one or more of the report variables, based on the relationships among variables.

78. The method of claim 77, further including:
creating an output spreadsheet that provides a display of values corresponding to the variables,
filtering one or more fields of the output spreadsheet dependent upon the report variables.

79. The method of claim 66, further including
classifying each of the variables as either dependent or independent variables, based on the relationships,
wherein
a value associated with each instantiation of the variable is dependent upon whether the variable is dependent or independent.

80. The method of claim 79, further including
creating an input spreadsheet that facilitates collection of data corresponding to each independent variable, and
creating an output spreadsheet that provides a display of values corresponding to one or more of the dependent variables, based on the input spreadsheet.

81. The method of claim 79, further including
creating an output spreadsheet that provides a display of values corresponding to one or more of the dependent variables, based on data associated with the independent variables, and
locking one or more fields of the output spreadsheet to ensure that the values displayed corresponding to each dependent variable conforms to the relationships among variables.

82. The method of claim 66, wherein
at least one of the relationships among variables is provided in natural-language form, and
receiving the one or more time-independent relationships among variables includes processing the at least one relationship using a natural-language dictionary.

83. The method of claim 66, wherein
receiving the one or more time-independent relationships among variables includes at least one of:
transforming a document image to text;
transforming handwriting to text; and
transforming speech to text.

84. A computer program that, when executed on a processor, causes the processor to:
receive one or more time-independent relationships among variables, and one or more categories,
create a time series model having a plurality of time periods, based on the categories and the relationships among variables, such that one or more of the variables are instantiated within each category within each time period of the time series model.

85. The computer program of claim 84, which causes the processor to
create one or more spreadsheets based on the time series model.

86. The computer program of claim 85, which causes the processor to
provide names to cells in the spreadsheet corresponding to the instantiation of each variable within each category, and
provide values to the cells based on the relationships among the variables and the names corresponding to the instantiations.

87. The computer program of claim 84, wherein:
the time periods are arranged in a time hierarchy, and
the instantiation of each variable within each time period conforms to the hierarchy.

88. The computer program of claim 84, wherein
the categories are arranged in a hierarchy, and
the instantiation of each variable within each category conforms to the hierarchy.

89. The computer program of claim 84, wherein
the categories include a first set of categories and a second set of categories,
the computer program causes the processor to
instantiate the second set of categories at each leaf node of the first set of categories to form a cross-category hierarchy, and
the instantiation of each variable within each category conforms to the cross-category hierarchy.

90. The computer program of claim 84, which causes the processor to
classify each of the variables as either dependent or independent variables, based on the relationships,
create an input spreadsheet that facilitates collection of data corresponding to each independent variable, and
create an output spreadsheet that provides a display of values corresponding to one or more of the dependent variables, based on the input spreadsheet.

91. The computer program of claim 84, which causes the processor to
create an output spreadsheet that provides a display of values corresponding to one or more of the dependent variables, based on data associated with the independent variables, and
lock one or more fields of the output spreadsheet to ensure that the values displayed corresponding to each dependent variable conforms to the relationships among variables.

92. The computer program of claim 84, which causes the processor to perform at least one of the following:
transform natural-language to structured-text;
transform a document image to text;
transform handwriting to text; and
transform speech to text.

93. A method comprising:
receiving as input one or more time-independent relationships among variables, and a timeframe,
automatically creating a time series model having a plurality of time periods, based on the timeframe and the relationships among variables, including instantiation of one or more of the variables within each time period of the plurality of time periods corresponding to the timeframe.

94. The method of claim 93, further including
creating one or more spreadsheets based on the time series model.

95. The method of claim 94, further including
creating the one or more spreadsheets based on one or more other time series models.

96. The method of claim 94, wherein
creating the one or more spreadsheets includes
providing names to cells in the spreadsheet corresponding to the instantiation of each variable, and
providing values to the cells based on the relationships among the variables and the names corresponding to the instantiations.

97. The method of claim 93, wherein
the time periods are arranged in a time hierarchy, and
the instantiation of each variable within each time period conforms to the hierarchy.

98. The method of claim 97, wherein
the instantiation of each variable at an upper level of the time hierarchy is configured to provide a value of the instantiation corresponding to a composite of instantiations at a lower level of the time hierarchy.

99. The method of claim 98, wherein
the composite includes one of: a summation, an average, and a peak value.

100. The method of claim 93, including
identifying report variables from among the variables,
wherein
the time series model includes instantiations of each of the variables that affect one or more of the report variables, based on the relationships among variables.

101. The method of claim 100, further including:
creating an output spreadsheet that provides a display of values corresponding to the variables,
filtering one or more fields of the output spreadsheet dependent upon the report variables.

102. The method of claim 93, further including
classifying each of the variables as either dependent or independent variables, based on the relationships,
wherein
a value associated with each instantiation of the variable is dependent upon whether the variable is dependent or independent.

103. The method of claim 102, further including:
creating an input spreadsheet that facilitates collection of data corresponding to each independent variable, and
creating an output spreadsheet that provides a display of values corresponding to one or more of the dependent variables, based on the input spreadsheet.

104. The method of claim 102, further including:
creating an output spreadsheet that provides a display of values corresponding to one or more of the dependent variables, based on data associated with the independent variables, and
locking one or more fields of the output spreadsheet to ensure that the values displayed corresponding to each dependent variable conforms to the relationships among variables.

105. The method of claim 93, wherein
at least one of the relationships among variables is provided in natural-language form, and
receiving the one or more time-independent relationships among variables includes processing the at least one relationship using a natural-language dictionary.

106. The method of claim 93, wherein
receiving the one or more time-independent relationships among variables includes at least one of:
transforming a document image to text;
transforming handwriting to text; and
transforming speech to text.

107. A computer program that, when executed on a processor, causes the process to:
receive as input one or more time-independent relationships among variables, and a timeframe,
create a time series model having a plurality of time periods, based on the timeframe and the relationships among variables, including instantiation of one or more of the variables within each time period of the plurality of time periods corresponding to the timeframe.

108. The computer program of claim 107, which further causes the program to
create one or more spreadsheets based on the time series model.

109. The computer program of claim 108, that further causes the program to
provide names to cells in the spreadsheet corresponding to the instantiation of each variable, and
provide values to the cells based on the relationships among the variables and the names corresponding to the instantiations.

110. The computer program of claim 107, wherein
the time periods are arranged in a time hierarchy, and
the instantiation of each variable within each time period conforms to the hierarchy.

111. The computer program of claim 107, which further causes the program to
identify report variables from among the variables,
wherein
the time series model includes instantiations of each of the variables that affect one or more of the report variables, based on the relationships among variables.

112. The computer program of claim 111, which further causes the program to
create an output spreadsheet that provides a display of values corresponding to the variables, and
filter one or more fields of the output spreadsheet dependent upon the report variables.

113. The computer program of claim 107, which further causes the program to
classify each of the variables as either dependent or independent variables, based on the relationships,
wherein
a value associated with each instantiation of the variable is dependent upon whether the variable is dependent or independent.

114. The computer program of claim 113, which further causes the program to:
create an input spreadsheet that facilitates collection of data corresponding to each independent variable, and
create an output spreadsheet that provides a display of values corresponding to one or more of the dependent variables, based on the input spreadsheet.

115. The computer program of claim 113, which further causes the program to:
create an output spreadsheet that provides a display of values corresponding to one or more of the dependent variables, based on data associated with the independent variables, and
lock one or more fields of the output spreadsheet to ensure that the values displayed corresponding to each dependent variable conforms to the relationships among variables.

116. A method comprising:
receiving as input one or more relationships among variables, and at least a first set of categories and a second set of categories,
creating a cross-category model, based on the first and second sets of categories, and
creating a category-variable model based on the cross-category model and the relationships among variables, including an instantiation of one or more of the variables within each cross-category of the cross-category model.

117. The method of claim 116, further including
creating one or more spreadsheets based on the category-variable model.

118. The method of claim 117, further including:
providing names to cells in the spreadsheet corresponding to the instantiation of each variable within each cross-category, and
providing values to the cells based on the relationships among the variables and the names corresponding to the instantiations.

119. The method of claim 116, further including:
classifying each of the variables as either dependent or independent variables, based on the relationships,
creating an input spreadsheet that facilitates collection of data corresponding to each independent variable, and
creating an output spreadsheet that provides a display of values corresponding to one or more of the dependent variables, based on the input spreadsheet.

120. The method of claim 119, further including
locking one or more fields of the output spreadsheet to assure that the values displayed corresponding to each dependent variable conforms to the relationships among variables.

121. A method comprising:
receiving as input one or more relationships among variables, and a set of categories arranged in a hierarchy, and
creating a category-variable model based on the cross-category model and the relationships among variables, including one or more instantiations corresponding to one or more of the relationships among variables at a plurality of levels of the hierarchy of categories.

122. The method of claim 121, further including
creating one or more spreadsheets based on the category-variable model.

123. The method of claim 122, further including:
providing names to cells in the spreadsheet corresponding to the instantiation of the one or more relationships among variables, and
providing values to the cells based on the relationships among the variables and the names corresponding to the instantiations.

124. The method of claim 121, wherein
the input method is configured to classify each of the variables as either dependent or independent variables, based on the relationships, and
the one or more instantiations corresponding to the one or more of the relationships among variables is dependent upon whether the variable is dependent or independent.

125. The method of claim 124, further including:
creating an input spreadsheet that facilitates collection of data corresponding to each independent variable, and
creating an output spreadsheet that provides a display of values corresponding to one or more of the dependent variables, based on the input spreadsheet.

126. The method of claim 124, further including
creating an output spreadsheet that provides a display of values corresponding to one or more of the dependent variables, based on data associated with the independent variables, and
locking one or more fields of the output spreadsheet to assure that the values displayed corresponding to each dependent variable conforms to the relationships among variables.
